(19) United States
(12) Patent Application Publication
(10) Pub. No.: US 2020/0398233 A1
(43) Pub. Date: Dec. 24, 2020

(54) SOLUTIONS FORMED FROM AMMONIUM CARBONATE/BICARBONATE AND AMMONIUM HYDROXIDE

(71) Applicant: SOLENIS TECHNOLOGIES, L.P., Wilmington, DE (US)

(72) Inventor: William S. Carey, Wallingford, PA (US)

(73) Assignee: SOLENIS TECHNOLOGIES, L.P., Wilmington, DE (US)

(21) Appl. No.: 16/904,624

(22) Filed: Jun. 18, 2020

Related U.S. Application Data
(60) Provisional application No. 62/863,638, filed on Jun. 19, 2019.

(51) Int. Cl. B01F 3/12; C01C 1/26

(52) U.S. Cl. CPC B01F 3/1214; C01C 1/26

(57) ABSTRACT

Solutions formed from ammonium carbonate and/or bicarbonate and ammonium hydroxide are disclosed. An amount of ammonium carbonate or bicarbonate is added to water with mixing. Furthermore, an amount of ammonium hydroxide is added to the water with mixing. Optionally, and amount of sodium hydroxide is added to the water with mixing. The ammonium carbonate or bicarbonate, the ammonium hydroxide, and the optional sodium hydroxide may be added to the water in any order. The solutions are useful in a variety of applications including formation of biocides and synthesis of urea.

### CROSS-REFERENCE TO RELATED APPLICATION

This application claims the benefit of U.S. Provisional Application No. 62/863,638, filed Jun. 19, 2019, which is hereby incorporated in its entirety by reference.

### TECHNICAL FIELD

The present disclosure generally relates to solutions used for industrial purposes, and in particular to solutions formed from ammonium carbonate and/or bicarbonate and ammonium hydroxide.

### BACKGROUND

Aqueous solutions of ammonium carbamate formed from solid ammonium carbamate find use in various industrial, commercial, and agricultural applications, such as biocides and fertilizer. The use of solid ammonium carbamate poses several challenges related to quality and handling. During transport of the solid ammonium carbamate, the solid ammonium carbamate is in equilibrium with its atmosphere resulting in partial decomposition of the ammonium carbamate depending on transport duration and temperature. The purity of solid ammonium carbamate can vary, thereby impacting the quality of the aqueous solution formed therefrom. The solid ammonium carbamate off-gases ammonia during handling when processing into an aqueous solution, thereby requiring environmental controls to reduce exposure to workers.

Accordingly, it is desirable to provide solutions similar to those prepared by the dissolution of ammonium carbamate in water, but which do not require the use of solid ammonium carbamate. Furthermore, other desirable features and characteristics will become apparent from the subsequent summary and detailed description and the appended claims, taken in conjunction with the accompanying drawings and the foregoing technical field and background.

### BRIEF SUMMARY

Various non-limiting embodiments of solutions formed from ammonium carbonate and/or bicarbonate and ammonium hydroxide, and various non-limiting embodiments of systems and methods for the same, are disclosed herein.

In a non-limiting embodiment, an amount of ammonium carbonate is added to water with mixing. Furthermore, an amount of ammonium hydroxide is added to the water with mixing. Optionally, and amount of sodium hydroxide is added to the water with mixing. The ammonium carbonate, the ammonium hydroxide, and the optional sodium hydroxide may be added to the water in any order. A weight ratio of ammonium hydroxide to water may be about 1:2 to about 1:20. A weight ratio of ammonium hydroxide to ammonium carbonate may be about 1:1 to about 1:10. A weight ratio of ammonium hydroxide to optional sodium hydroxide may be about 1:1 to about 1:10.

In a non-limiting embodiment, an amount of ammonium bicarbonate (as used herein, the term “ammonium bicarbonate” means the commercially available 50:50 mixture of ammonium carbonate and ammonium bicarbonate) is added to water with mixing. Furthermore, an amount of ammonium hydroxide is added to the water with mixing. Optionally, and amount of sodium hydroxide is added to the water with mixing. The ammonium bicarbonate, the ammonium hydroxide, and the optional sodium hydroxide may be added to the water in any order. A weight ratio of ammonium hydroxide to water may be about 1:2 to about 1:20. A weight ratio of ammonium hydroxide to ammonium bicarbonate may be about 1:0.5 to about 1:5. A weight ratio of ammonium hydroxide to optional sodium hydroxide may be about 1:1 to about 1:10.

This brief summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the systems and methods as described herein. Furthermore, there is no intention to be bound by any theory presented in the preceding background or the following detailed description.

It has been observed that ammonium carbamate, when added to water to form a solution, will equilibrate over time (for example 12 to 24 hours) to an approximate 50:50 ratio of carbamate and carbonate/bicarbonate salt. Given the difficulties in using solid ammonium carbamate as detailed above, it has been investigated whether a similar solution can be formed from ammonium carbonate or bicarbonate and ammonium hydroxide, optionally with the addition of sodium hydroxide (caustic).

Accordingly, in a non-limiting embodiment, in a vessel, an amount of ammonium carbonate may be added to water with mixing. Furthermore, an amount of ammonium hydroxide may be added to the water with mixing. Optionally, an amount of sodium hydroxide may be added to the water with mixing. Furthermore, in another non-limiting embodiment, in a vessel, an amount of ammonium bicarbonate may be added to water with mixing. Furthermore, an amount of ammonium hydroxide may be added to the water with mixing. Likewise, optionally, an amount of sodium hydroxide may be added to the water with mixing. The resulting solution includes a mixture of water, ammonia, and sodium or ammonium salts of carbamate, carbonate, and bicarbonate.

For solutions utilizing ammonium carbonate, a weight ratio of ammonium hydroxide to water may be about 1:2 to about 1:20, such as about 1:2 to about 1:15. A weight ratio of ammonium hydroxide to ammonium carbonate may be about 1:1 to about 1:10, such as about 1:1 to about 1:5. A weight ratio of ammonium hydroxide to optional sodium hydroxide may be about 1:1 to about 1:10, such as about 1:1 to about 1:5.

For solutions utilizing ammonium bicarbonate, a weight ratio of ammonium hydroxide to water may be about 1:2 to about 1:20, such as about 1:2 to about 1:15. A weight ratio of ammonium hydroxide to ammonium bicarbonate may be about 1:0.5 to about 1:5, such as about 1:0.5 to about 1:3. A weight ratio of ammonium hydroxide to optional sodium hydroxide may be about 1:1 to about 1:10, such as about 1:1 to about 1:5.

The solution disclosed herein may have a pH of at least about 9.0, alternatively at least about 9.5, or alternatively at least about 10.0. The speciated solution may have a pH of from about 9.0 to about 11.5, alternatively from about 9.5 to about 11.0. pH of the solution may be utilized to determine speciation of compounds contained within the speciated solution. In embodiments, an increase in the amount of sodium hydroxide utilized to form the solution results in an increase in the pH of the solution.

While the components of the solution can be added to the water in any order, in formulations containing sodium hydroxide, an exemplary order of addition to the water is sodium hydroxide followed by carbonate/bicarbonate salt followed lastly by ammonium hydroxide. Moreover, in formulations that do not contain sodium hydroxide, an exemplary order of addition to the water is ammonium hydroxide followed by carbonate/bicarbonate salt. There may be a period of time of about 1 minute to about 100 minutes between the addition of each component, to allow for dissolution.

The mixing may be performed under a variety of temperatures and pressures. For example, the water may be kept at a temperature of from about 5° C. to about 50° C., such as about 10° C. to about 30° C. In a particular embodiment, the mixing is performed at room temperature of about 20° C. to about 25° C. Additionally, for example, the mixing may be performed in a vessel at standard atmospheric pressure or greater, such as about 1 atm to about 5 atm, or about 1 atm to about 3 atm. In a particular embodiment, the mixing is performed at standard atmospheric pressure.

The solution disclosed herein may have a conductivity at 25° C. of at least about 75 mS/cm, alternatively at least about 85 mS/cm, or alternatively at least about 95 mS/cm. The solution disclosed herein may have a conductivity at 25° C. of from about 75 mS/cm to about 160 mS/cm, alternatively from about 85 mS/cm to about 110 mS/cm. Conductivity of the solution disclosed herein may also be utilized to determine speciation of compounds contained within the solution.

The solution disclosed herein may have a nitrogen content of at least about 40,000 ppm, alternatively at least about 50,000 ppm, or alternatively at least about 60,000 ppm. The speciated solution may have a nitrogen content of from about 40,000 ppm to about 190,000 ppm, alternatively from about 50,000 ppm to about 150,000 ppm.

The solutions disclosed herein may be utilized in a variety of applications including, but not limited to, formation of biocides (for example in combination with a hypochlorite oxidant) and synthesis of urea.

### ILLUSTRATIVE EXAMPLES

The present disclosure is now illustrated by the following non-limiting examples. It should be noted that various changes and modifications can be applied to the following example and processes without departing from the scope of this invention, which is defined in the appended claims. Therefore, it should be noted that the following examples should be interpreted as illustrative only and not limiting in any sense.

Formulations for exemplary solutions in accordance with the present disclosure may be prepared as follows (in all cases using a suitably-sized vessel capable of providing mixing to the components):

### Comparative Example 1

### Ammonium Carbamate Solution

To a sealed vessel containing 804.4 parts water is charged 195.6 parts ammonium carbamate (99.7%) with mixing. The resulting solution was allowed to equilibrate for 16 hours at room temperature before analysis.

### Example 1

### Ammonium Bicarbonate+Ammonium Hydroxide

To a sealed vessel containing 631.0 parts water is charged 170.1 parts ammonium hydroxide (25% as NH₃) with mixing. The resulting solution was adjusted to room temperature and then 198.9 parts ammonium bicarbonate (99.3%) was charged and mixed until a clear solution was obtained. The resulting solution was allowed to equilibrate for 16 hours at room temperature before analysis.

### Example 2

### Ammonium Carbonate+Ammonium Hydroxide

As in Example 1 utilizing 719.2 parts water, 84.5 parts ammonium hydroxide (25% as NH3), and 196.2 parts ammonium carbonate (99.3%).

### Example 3

### Ammonium Bicarbonate+Sodium Hydroxide+Ammonium Hydroxide

To a sealed vessel containing 318.8 parts water is charged 312.2 parts aqueous sodium hydroxide (32%) with mixing. The resulting solution was adjusted to room temperature and then 198.9 parts ammonium bicarbonate (99.3%) was charged and mixed until a clear solution was obtained. 170.1 parts ammonium hydroxide (25% as NH₃) was then charged. The resulting solution was allowed to equilibrate for 16 hours at room temperature before analysis.

### Example 4

### Ammonium Carbonate+Sodium Hydroxide+Ammonium Hydroxide

As in Example 3 utilizing 407.0 parts water, 312.2 parts sodium hydroxide (32%), 196.2 parts ammonium carbonate (99.3%) and 84.5 parts ammonium hydroxide (25% as NH₃).

Equilibrium pH of all samples was approximately 10.6±0.2. Equilibration of the samples was determined by monitoring the solutions for stabilization of the pH; typically storage at room temperature for 18 hours was sufficient. The compositions of the samples were then conducted by first performing a quantitative ¹³C NMR analysis to determine the mole ratio of carbamate to (bi)carbonate species: reference Fabrizio Mani, et al., “CO₂ absorption by aqueous NH₃ solutions: speciation of ammonium carbamate, bicarbonate and carbonate by a ¹³C NMR study”, Green Chem., 2006, 8, pp 995-1000. The molar ratio of bicarbonate:carbonate was then estimated based on a modelling analysis utilizing the CurTiPot freeware for acid-base equilibrium calculations: reference Gutz, I. G. R., “CurTiPot—pH and AcidpBase Titration Curves: Analysis and Simulation Software”, version 3.5.4, http://www2.iq.usp.br/docente/gutz/Curtipot.html. In the CurTiPot modelling the pKa for carbamic acid was set at 5.8, all other species in the analyses utilized the default pKa value. The composition estimation of Examples 3 and 4 comprising sodium hydroxide assumed that the sodium present satisfied the (bi)carbonate species demand first. The estimated molar ratios of the various species in the examples was then converted to weight percent and summarized in Table 1.

TABLE 1

| | Comparative | | | | |
|---|---|---|---|---|---|
| | Example 1 | Example 1 | Example 2 | Example 3 | Example 4 |
| Carbamate:(Bi)carbonate (mole | 50:50 | 50:50 | 50:50 | 50:50 | 50:50 |
| %) | | | | | |
| Bicarbonate:Carbonate (mole %) | 98.2:1.8 | 98.2:1.8 | 98.2:1.8 | 79.7:20.3 | 79.7:20.3 |
| Ammonium Carbamate (wt %) | 9.76 | 9.76 | 9.76 | 1.98 | 1.98 |
| Ammonium Bicarbonate (wt %) | 9.70 | 9.70 | 9.70 | — | — |
| Ammonium Carbonate (wt %) | 0.22 | 0.22 | 0.22 | — | — |
| Sodium Carbamate (wt %) | — | — | — | 8.27 | 8.27 |
| Sodium Bicarbonate (wt %) | — | — | — | 8.37 | 8.37 |
| Sodium Carbonate (wt %) | — | — | — | 2.69 | 2.69 |
| Ammonia (wt %) | 2.09 | 2.09 | 2.09 | 5.96 | 5.96 |

It is observed in Examples 1 and 2 that both ammonium bicarbonate and bicarbonate solutions formulated with ammonia were analyzed and found to yield a composition equivalent to equilibrated ammonium carbamate in water (Comparative Example 1). Examples 3 and 4 demonstrate the impact of formulating additionally with sodium hydroxide to shift the equilibrium of the species in the system. It is noted that for all the examples provided the weight percent NH₃ was maintained consistent at 8.53 wt % for comparison purposes.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It is understood that various changes may be made in the function and arrangement of elements described in an exemplary embodiment without departing from the scope of the disclosure as set forth in the appended claims.

What is claimed is:

1. A method for forming an equilibrated solution that includes ammonium carbamate, the method comprising the steps of:
adding an amount of ammonium carbonate to water with mixing; and
adding an amount of ammonium hydroxide to the water with mixing.

2. The method of claim 1, further comprising:
adding an amount of sodium hydroxide to the water with mixing.

3. The method of claim 2, wherein:
a weight ratio of ammonium hydroxide to sodium hydroxide is about 1:1 to about 1:10.

4. The method of claim 1, wherein:
a weight ratio of ammonium hydroxide to water is about 1:2 to about 1:20.

5. The method of claim 1, wherein
a weight ratio of ammonium hydroxide to ammonium carbonate is about 1:1 to about 1:10.

6. A method for forming an equilibrated solution that includes ammonium carbamate, the method comprising the steps of:
adding an amount of ammonium bicarbonate to water with mixing; and
adding an amount of ammonium hydroxide to the water with mixing.

7. The method of claim 6, further comprising:
adding an amount of sodium hydroxide to the water with mixing.

8. The method of claim 7, wherein:
a weight ratio of ammonium hydroxide to sodium hydroxide is about 1:1 to about 1:10.

9. The method of claim 6, wherein:
a weight ratio of ammonium hydroxide to water is about 1:2 to about 1:20.

10. The method of claim 6, wherein
a weight ratio of ammonium hydroxide to ammonium bicarbonate is about 1:0.5 to about 1:5
